(19) United States
(12) Patent Application Publication
(10) Pub. No.: US 2023/0121189 A1
(43) Pub. Date: Apr. 20, 2023

(54) SYSTEM AND METHOD FOR CREATING AND SHARING EVENT VISUALIZATIONS FOR SCHEDULED EVENTS

(71) Applicant: Private Island, Inc., Tiburon, CA (US)

(72) Inventor: Nicholas Duro, Tiburon, CA (US)

(21) Appl. No.: 17/505,260

(22) Filed: Oct. 19, 2021

(51) Int. Cl. G06T 19/00; G06F 16/29

(52) U.S. Cl. CPC G06T 19/00; G06F 16/29; G06Q 50/01

(57) ABSTRACT

The present disclosure generally relates to a system and method for creating and sharing event visualizations. More specifically, the present disclosure relates to generating event visualizations that are fully contained expressions of future experiences, representing venue spaces, and including items and services, for example. Avatars of the attendees can be overlaid onto each event visualization to visualize the attending guests. Each event visualization can be shared across one or more social network platform and via SMS, e-mails, etc. for inviting guests to attend a private event while maintaining control which guests to include. Additionally, the event visualizations can be shown as annotations on a map filterable by geographic location and time.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

The present invention generally relates to a system and method for creating and sharing event visualizations for scheduled events.

### BACKGROUND

The development of computer networking has led to many different types of applications to allow network users to socially interact. For example, social networks such as Facebook, Instagram, Twitter, LinkedIn, Tumblr, and Snapshot provide users with platforms in which to create personal spaces on the Web that can be used to post personal profiles and share information. Depending on interests, users can join various groups of like-minded persons. In many cases, users can create unique usernames and can post their picture and/or an avatar associated with their profile.

Some social networks enable users to post invitations to events, as an alternative to the traditional postal or telephone methods of initiating parties and other events. Using the Internet, a planner or host of an event can create an HTML page with information about the event, such as date, time, and location which can then be posted to the social network. Additionally, the user can provide links to maps, directions, and other useful information relating to the event. The links can be addresses such as uniform resource locators (“URL”). Alternatively, event information can be sent through electronic mail (e-mail) or text messaging. The advantage of each of the foregoing is that event information can be made available to a large group of people with little cost and effort. Alternative means, such as placing phone calls or mailing material through a postal service, would require a great amount of labor, time, and economic expense. The drawback of posting event invitations on current platforms includes the fact that they are open to anyone who accesses the link. Once the opportunity is seen, the public can buy a ticket or join the event and thus a private event cannot be shared electronically.

### SUMMARY

The present disclosure generally relates to a system and method for creating and sharing event visualizations. More specifically, the present disclosure relates to generating event visualizations that are fully contained expressions of future experiences, representing venue spaces, and including items and services, for example. Avatars of the attendees can be overlaid onto each event visualization to visualize the attending guests. The avatars are each representative of a user profile, and when clicked on, an avatar shows a user profile. These will not only be shown on the visualizations, but also on the host's notification requests, group message, and guest list and details pages. Each event visualization can be shared across one or more social network platform (and via SMS, e-mails, and so forth). Additionally, the event visualizations can be shown as annotations on a map filterable by geographic location and time. A key element of the event visualization is that after inputting the required data, a user is presented with both an illustration and organized written description of the event opportunity, which can be shared widely. The event can be marked as a private event or one which is publicly available. Viewers can request to join, which gives the host an opportunity to review the viewer's profile and accept or decline the request. When accepted, the new participant may be issued a ticket (if applicable) and included in the group chat, shared photo gallery, and receive notifications about changes or updates.

In one embodiment, a system for creating an event visualization for a scheduled event is disclosed. In one embodiment, the system comprises a server, a plurality of computing devices linked to the server via the Internet. The user is capable of requesting creation of the event visualization for the scheduled event using one of the computing devices. The event visualization includes a 3D graphical illustration having a plurality of graphical information associated with the 3D graphical illustration.

In one embodiment, a method for creating an event visualization is disclosed. At one step, the system obtains event information from the user. At another step, properties of the event are identified based on the obtained event information. At another step, the system selects a background layer for the event visualization. At another step, the system selects a plurality of foreground layers, each based on one of the identified properties of the event. Further, the system combines (flattens) the background layer and the foreground layers, thereby forming or generating the event visualization for the scheduled event. The created event visualization can be shared on social networks for inviting guests to attend the event while maintaining control over joining guests. The event may be designated as a public event or one which is private.

In one embodiment, the background layer comprises a 3D graphical illustration such as an isometric illustration. In one embodiment, at least one of the identified properties of the event includes the attendees. The attendees can be represented as avatars in one of the foreground layers. In one embodiment, the event visualization is placed on a visualization map along with other visualization events. The event visualizations may be published on a social network. In one embodiment, an event visualization is published on more than one social network. In one embodiment, the event visualization is disseminated by one or more of email, text message, QR code, and social media posting. In one embodiment, the visualization map is filterable by one or more of time, location, and category.

Other objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIGS. 1A-1C illustrate an example system for creating and sharing an event visualization for a scheduled event, according to an embodiment.

FIG. 2 illustrates an example event visualization map, according to an embodiment.

FIGS. 3-4 illustrate example screens useable for creating the event visualization, according to an embodiment.

FIGS. 5-7 illustrate example 3D graphical illustrations useable for the event visualizations.

FIG. 8 illustrates an example of an event illustration, according to an embodiment.

FIG. 9 is an example flowchart of a method for generating an event visualization map, according to an embodiment.

FIG. 10 is an example flowchart of a method for creating the event visualization, according to an embodiment.

FIG. 11 shows an example technique for layering an event visualization, according to an embodiment.

FIGS. 12A-12B is an example flowchart of a method for acceptance of an event invitation, according to an embodiment.

FIGS. 13-28 illustrate example display screens for an implementation of a mobile device application for an example mobile device application (“app”) useable in conjunction with the systems and methods of the present disclosure.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

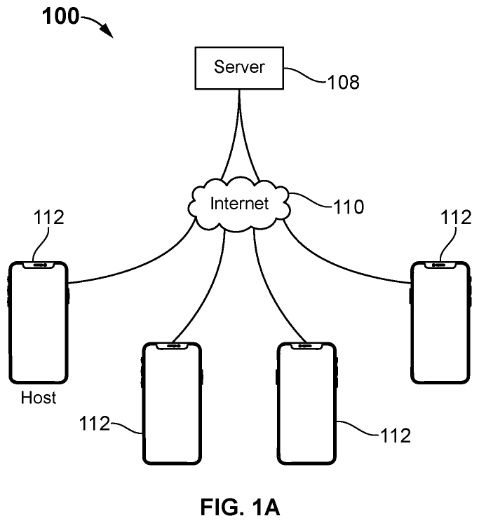

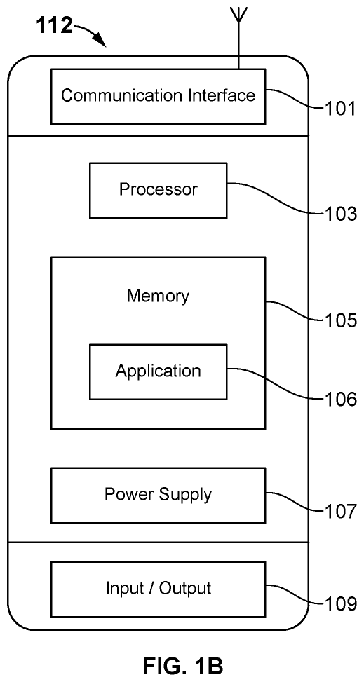

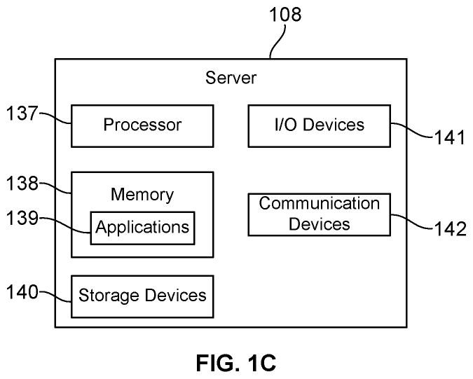

Referring to FIG. 1A, a block diagram of a system for creating and sharing an event visualization 100, according to an embodiment is illustrated. As will be described in greater detail, the system 100 is configured to enable a user to dynamically create an event visualization representing key features of the event, shareable across one or more social networks and presentable on an event visualization map filterable by geographic location and time frame.

In one embodiment, the system 100 includes a server 108 and a plurality of computing devices 112 connected to the server 108 via the Internet 110. Although the server 108 is shown as a single entity, it is to be understood that the server 108 may include numerous computing devices hosted in multiple locations. In general, the server 108 represents various cloud-based services capable of implementing the back-end portions of the invention. The computing devices 112 are in communication with the server 108 via the Internet 110. The server 108 can host a social network, and the computing devices 112 can be devices used by members of one or more social network. It is to be understood that although only four computing devices 112 are shown, that the system 100 can accommodate practically any number of computing devices 112.

FIG. 1B shows a block diagram of a typical computing device 112 useable in conjunction with the system 100 for creating the event visualization. The computing device 112 may be used by a host of an event. In one embodiment, the computing device 112 can also be used by any member of the social network to socially interact. It is to be understood that the same type of computing device 112 can be used by a host of the event and/or by an attendee. Although the computing device 112 is drawn to resemble a smartphone, it is to be understood the computing device 112 could be, but not limited to, a smartphone, a laptop computer, a desktop computer, a tablet computer, a Web-enabled television, and so forth.

As depicted, the computing device 112 includes a communication interface 101, a processor 103, a power supply 107, and input/output 109. In an embodiment, the communication interface 101 controls various input/output devices including a digital camera, a connector port, a headphone jack, and a built-in speaker and microphone. In various embodiments, the communication interface 101 may also include a touch screen. The processor 103 includes a central processing unit (CPU). The memory can include ROM/RAM, flash memory and the like. The power supply 109 may include a re-chargeable battery and a power charger. Application 106 is stored in the memory 105 and includes program code non-transitorily embedded thereon. This program code includes various programs executable by the processor 103 to interface with the server 108, record video/audio, process text, encrypt data, and so forth. In general, the application 106 will include the software for the “client-side” methods described herein. These client-side methods will allow users to interface with a social network hosted on the “server side” (on server 108) and will also allow users to host an event, as will be described in detail. In some cases, the software will include software that comes with the computing device 112 or was installed previously, such as a QR code reader, and video/audio recording software.

FIG. 1C shows a block diagram of a typical computing system useable as the back-end server 108. The server 108 is programmed in accordance with the “server-side” methods described herein. The server 108 comprises a computer processor 137, memory (RAM, ROM, etc.) 138 (including memory for non-transitorily storing program code comprising applications 139), fixed and removable storage devices 140 for example, hard drive, memory stick, solid state drives, etc., input/output devices 141, for example, keyboards, display monitors, pointing devices, printers, etc., and communication devices 142, for example, Ethernet cards, Wi-Fi cards, modems, etc. Although the Internet 110 is depicted as being used for communication among the illustrated entities, it is to be understood that other network elements could, alternatively, or in addition, be used. These may include any combination of wide area networks, local area networks, public switched telephone networks, wireless or wired networks, intranets, or any other communication system.

The system 100 includes a distributed application (106, 139) which is partitioned between a service provider or the server 108 and a plurality of service requesters or computing devices 112. Under this arrangement, a request-response protocol, such as hypertext protocol (HTTP), may be employed such that a client (computing device 112) may initiate requests for services from the server 108 and the server 108 may respond to each respective request by, for example, executing an application, and (where appropriate) sending results to the client via the computing devices 112. The server 108 may also include a database and a logic engine operatively linked to the server, allowing the application to query and store data therein. It is to be understood that in some embodiments, however, substantial portions of the application logic may be performed on the client using, for example, the AJAX (Asynchronous JavaScript and XML) paradigm to create an asynchronous web application. Furthermore, some portions of the application logic could be performed using a browser extension. Moreover, it is to be understood that in some embodiments the application may be distributed among a plurality of different servers (not shown).

In the following description of the present invention, exemplary methods for performing various aspects of the present invention are disclosed. It is to be understood that the steps illustrated herein may be performed by executing computer program code written in a variety of suitable programming languages, such as C, C++, C#, Visual Basic, and Java. It is also to be understood that the software of the invention will preferably further include various Web-based applications that can be written in HTML, PHP, JavaScript, jQuery, etc., accessible by the clients using computing devices 112 through a suitable browser 145, for example, Internet Explorer, Microsoft Edge, Mozilla Firefox, Google Chrome, Safari, Opera or as an application running on a suitable mobile device, for example, an iOS or Android “app”.

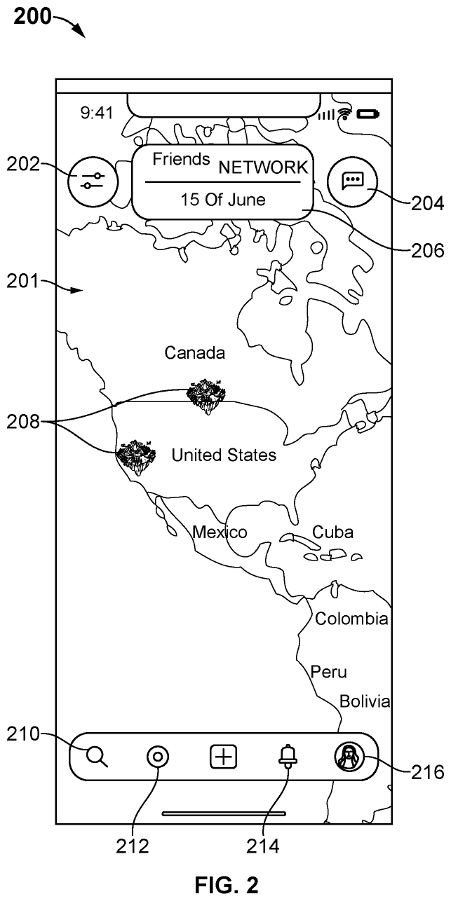

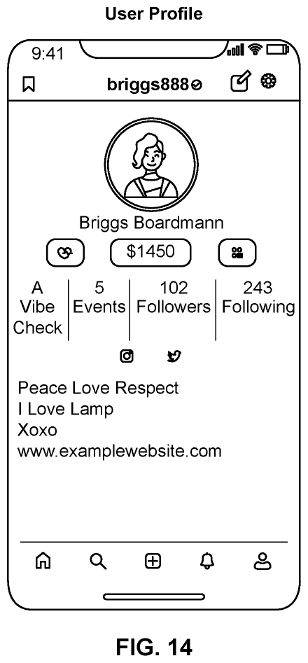

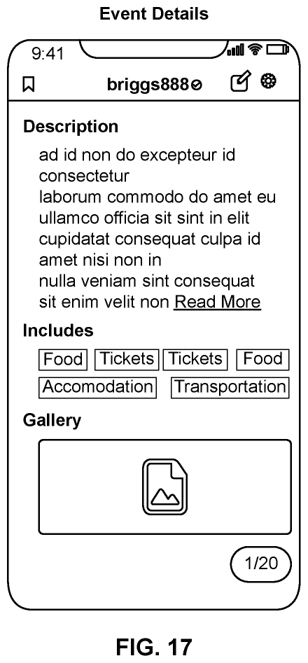

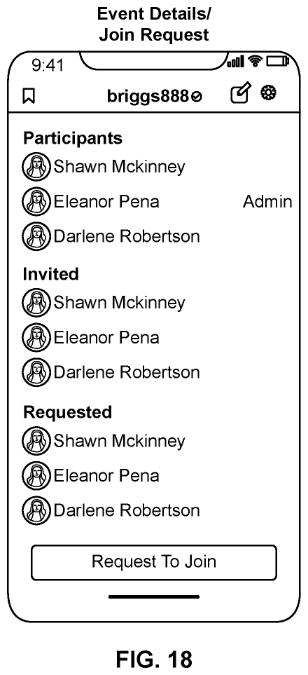

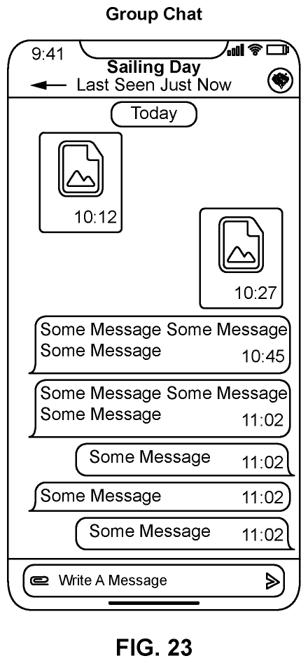

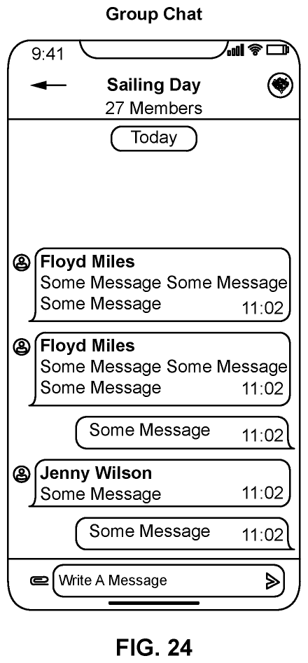

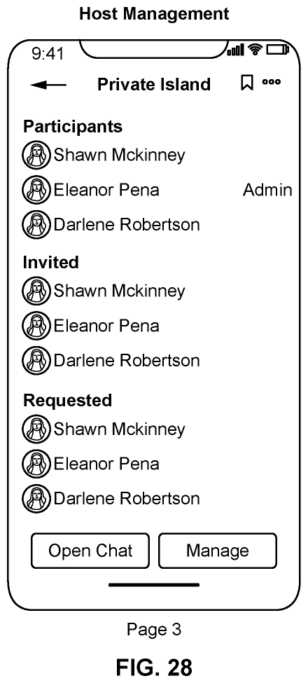

Referring to FIG. 2, an event visualization map 200, according to an embodiment is illustrated. The event visualization map 200 can be rendered in a browser or displayed by an application (“app”) executing on the computing device 112 (which may be useable with the example “app” described in conjunction with FIGS. 14-28). In an embodiment, when the user logs into the system 100, the user is taken to the event visualization map 200 and sees a map 201. At first, the map 201 may depict the “entire world.” The map 201 may be automatically zoomed-in based on the user location. The map 201 is geographically accurate and shows current and upcoming event opportunities, which are depicted as the event visualizations 208 representative of events such as trips, parties, and activities which have been posted by users. Clicking on an event visualization 208, will make the event visualization 208 larger and reveal additional information as to the event. In an embodiment, the event visualization map 200 includes various graphical widgets including a filter selector 202, a chat window icon 204, a calendar/timeline selector 206, a scheduled events display 208, a search icon 210, a location icon 212, a notification icon 214, and a profile icon 216. In an embodiment, the user may search for an event by clicking on the search icon 210 and thereupon entering search terms in a text box that will appear. The user may browse/edit their profile by clicking the profile image 216. The event visualization map 200 may be filtered by time, effectively turning the event visualization map 200 into a visual timeline. The calendar/timeline selector 206 is scrollable. The user scrolls right to visit only days in which a future event is scheduled (empty days are not selectable). Scrolling left one can view “all past events”. In an embodiment, events may also be filtered by geographic area, such as, for example, by limiting events to those within a 20-mile radius of a particular city. Events can further be filtered by social relationship (displaying events attended by either “friends” and the events they are involved with as hosts or participants) as opposed to the default setting that shows all events of all users. It is to be understood that the example filters discuss above are not meant to be limiting.

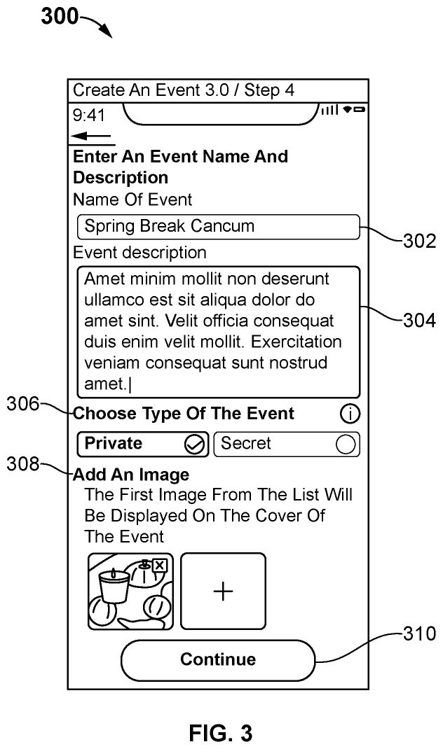

Referring to FIG. 3, an example screen 300 for creating an event visualization, according to an embodiment, is shown. In the illustrated embodiment, the screen 300 is configured to enable the user to add an event name 302, input a textual description of the event 304, and to designate the event as a private/secret event 306. In an embodiment, the screen 300 is further configured to enable the user to add one or more images or videos 308 related to the scheduled event. Further, the user may save all the entered details and proceed by clicking the continue button 310, which then brings the next screen, screen 400, in view to continue the event visualization creation process.

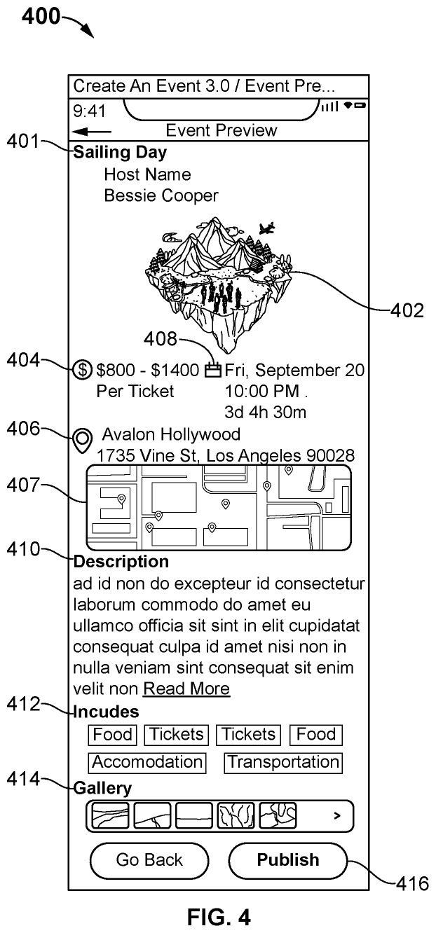

Referring to FIG. 4, the screen 400 shows an example event preview. As depicted, the screen 400 includes the event name 401 and the event visualization 208. The screen 400 also includes event information that can be input such as a ticket price 404, an event address 406, a scheduled event date/time 408, a description/written details section 410, and event features 412 (such as food, tickets, accommodation, and transportation, etc.). An event location map 407 may be automatically generated based on the input event address 406. A photo gallery 414 may also be provided. As will be described in greater detail, avatars of attendees may be added to the event visualization 208 as attendees are accepted by the host. The event visualization can be published by clicking the publish button 416. The avatar is representative of a user profile, and when clicked on the avatar then it will show the corresponding user profile. These will be shown not only on the event visualizations (e.g., as persons situated on a private island), but also on the host's notification requests, group messages, guest list, and details page.

It is to be appreciated that additional information may be provided. In an embodiment, a pull-down menu of event categories is provided. These categories, when selected, expand to a list of related subcategories. The first category buttons remain in place, and if an alternate super category is clicked the originally opened subcategories disappear and new appropriate subcategories appear under the clicked category. In an embodiment, the categories include adventure, party, and concert and the sub-categories of the party include birthday party, house party, graduation party, holiday party, picnic, dinner party, yacht party, and corporate event, etc. In an embodiment, the sub-categories for the concert include DJ party, singer, live rock band, and live classical band, etc. In another embodiment, however, the event category may be determined using the user inputs, a knowledge base, and a set of rules and/or heuristics. The knowledge base may include categories of events associated with venues. For example, the knowledge base may associate a particular venue with a karaoke bar.

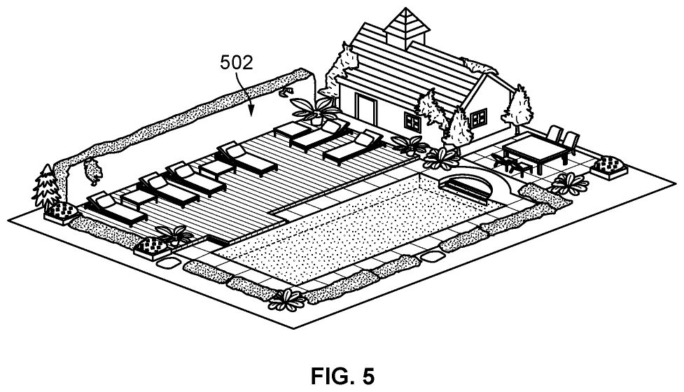

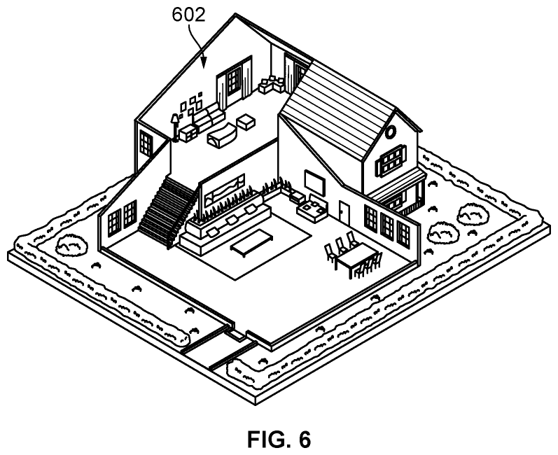

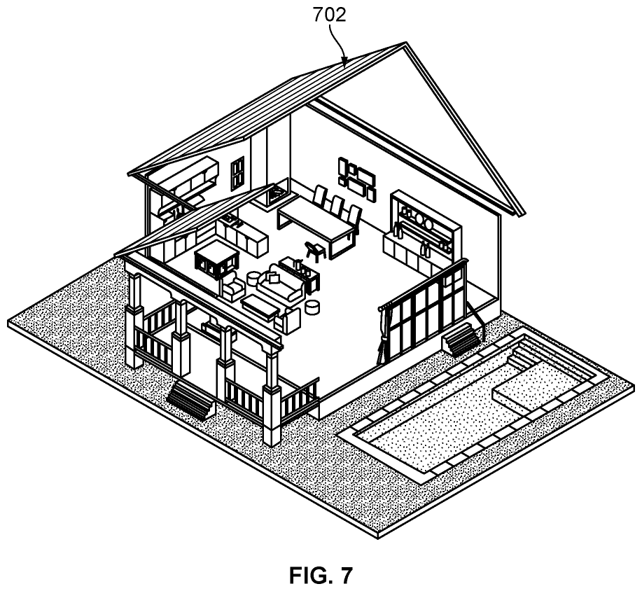

Referring to FIGS. 5-7, example 3D graphical illustrations, according to an embodiment, are shown. The 3D graphical illustrations will be used as the background layers of event visualizations 208 (as shown in FIGS. 2 and 4). The example 3D graphical illustrations 502, 602, 702 are isometric illustrations each depicting a key aspect of a scheduled or upcoming event. The illustrated 3D graphical illustrations are templates representative of venues, trips, parties, and activities given by the user in the screens (as shown in FIGS. 4 and 5). All the 3D graphical illustrations are meant to represent private social events hosted in a variety of venues include, but not limited to, nature, buildings, destination, transportation such as party buses and party cruise ships, and other unique venues. In an embodiment, the 3D graphical illustrations are obtained from a content library and/or are constructed dynamically by a graphics engine. There is an additional dynamic selection process to determine the included services such as accommodation, transportation, entertainment, equipment, and experiences.

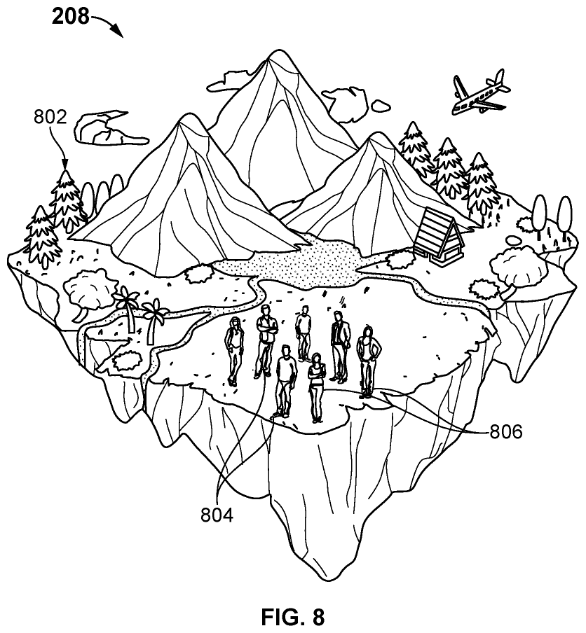

Referring to FIG. 8, an example event visualization 208, including a graphical illustration 802, is shown. The 3D graphical illustration 802 is an isometric illustration of a private island. The private island is a template that whimsically illustrates a venue where a party or other gathering will take place, such as a residence, commercial building, beach, area in nature, restaurant, entertainment center, activity experience or a travel location, such as a generic tropical island or a specific city or country, such as Honolulu, Hi. Additionally, avatars (804 and 806) associated with the approved guests are implanted onto the private island to visualize the attending guests. The 3D graphical illustrations may be branded to specific brand partnerships or remain generic in a unique, distinguishing style. Specific destinations may have custom islands selected for them based on geographical inputs, for example.

In an embodiment, the event visualizations may be fixed or animated. For example, the event visualizations may be a still image, an animated GIF, a sprite, or even a short video. In some embodiments, a photo/picture to express the QR codes (or other types of 3D bar codes) linking back to the events can be superimposed on the event visualization or provided adjacent thereto. In an embodiment, the system 100 is further configured to enable the users to add music or sounds from an audio library to their posting.

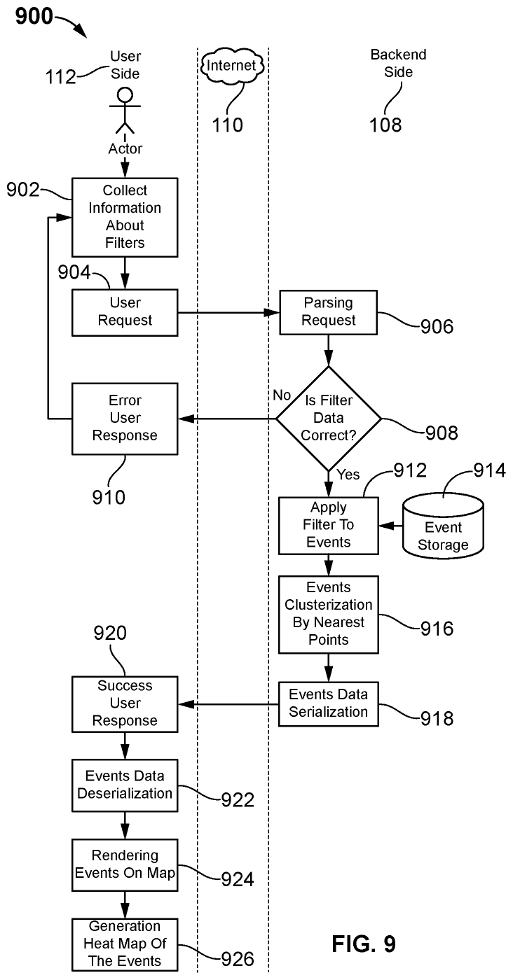

Referring to FIG. 9, a flowchart 900 of a method for generating an event visualization map 200 is shown. Initially, at step 902, event filters are collected from the user computing device 112. As mentioned, event filters may include date ranges and geographic locations. However, the event filters may also include other aspects of an event, such as the types of events for which the user is interested in exploring. At step 904, the user computing device 112 sends a request along with the collected event filters to the server 108. At step 906, the event filters are parsed. At step 908, a determination is made as to whether the provided event filters are correct (valid). If the event filters are incorrect (invalid), then an error message is generated for the user at step 910, and control returns to step 902. However, if it is determined that the event filters are correct, at step 912, the event filters are applied to a set of events retrieved at step 914 from an event storage. At step 916, the filtered events are identified and clustered by nearest geographical points. At step 918, the event data is serialized. For example, the event data is converted or transformed into an internal format, such as JSON format. At step 920, an indication that the request was successful is received by the computing device 112. At step 922, the event data is deserialized. At step 924, the events are rendered on a map. At step 926, the rest of the event visualization map including various graphical widgets, such as shown on the event visualization map 200 (FIG. 2), is generated.

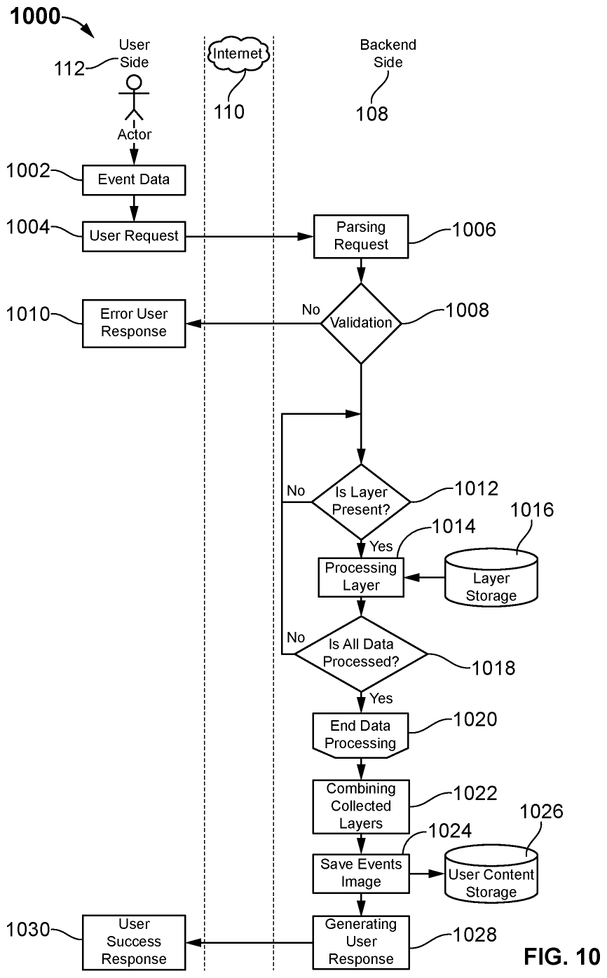

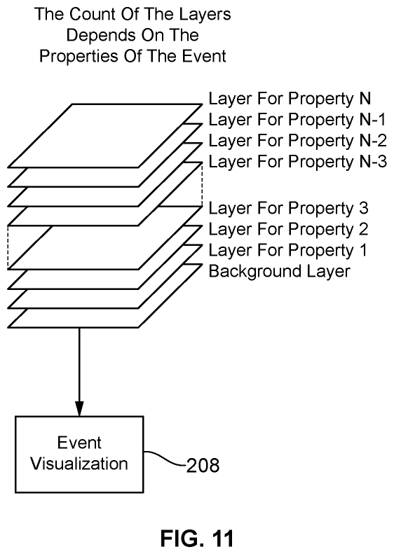

Referring to FIGS. 10-11, a flowchart 1000 depicting a method for creating an event visualization, according to an embodiment, is illustrated. Initially, at steps 1002 and 1004, respectively, the user provides event data and submits a new event creation request. This can be done by using the screen 300 (shown in FIG. 3), for example. At step 1006, the user request is parsed. At step 1008, the user request is validated. If the user request is deemed invalid, then control passes back to the user device 112 where an error is indicated at step 1010. However, if the user request is deemed valid, then at steps 1012-1020, the event visualization 208 is iteratively built. In building the event visualization 208, the background layer is initially selected. Foreground layers 1 to N are then one-by-one placed on top of the background layer, as depicted in FIG. 11. Accordingly, at step 1012, a determination is made as to whether a layer is present. The initial layer will be the background layer, so the first time through the loop, at step 1014, the background layer is processed. In that case, an appropriate 3D graphical illustration, such as one depicting a private island (graphical illustration 802), is selected from layer storage 106 and made the background layer. At step 1018, a determination is made as to whether all the data is processed. Control passes back to step 1012 if there are other layers not yet processed and continues at step 1014 where the next layer. Examples of foreground layers include avatars of attendees; a graphical representation of a mode of travel, such as an airplane or ship; a graphical representation of an activity, such a depiction of a skier, a surfboard, or people dancing; a graphical representation of a weather condition, such a depiction of falling snow or a shining sun; a link to media such as a photo or a video provided by the host; a logo for an organization; a logo for an event sponsor; a photo or illustration of a speaker; and event information, such as event title, event schedule). Once all layers are built, the iteration terminates; control is passed to step 1020, and in step 1022, the layers are combined (flattened). In step 1024, the created event visualization 208 is saved in the user content storage 1026. Finally, in step 1026, a user success message is generated, and, in steps 1028 and 1030, the message sent to the user computing device 112 where it is outputted to the user.

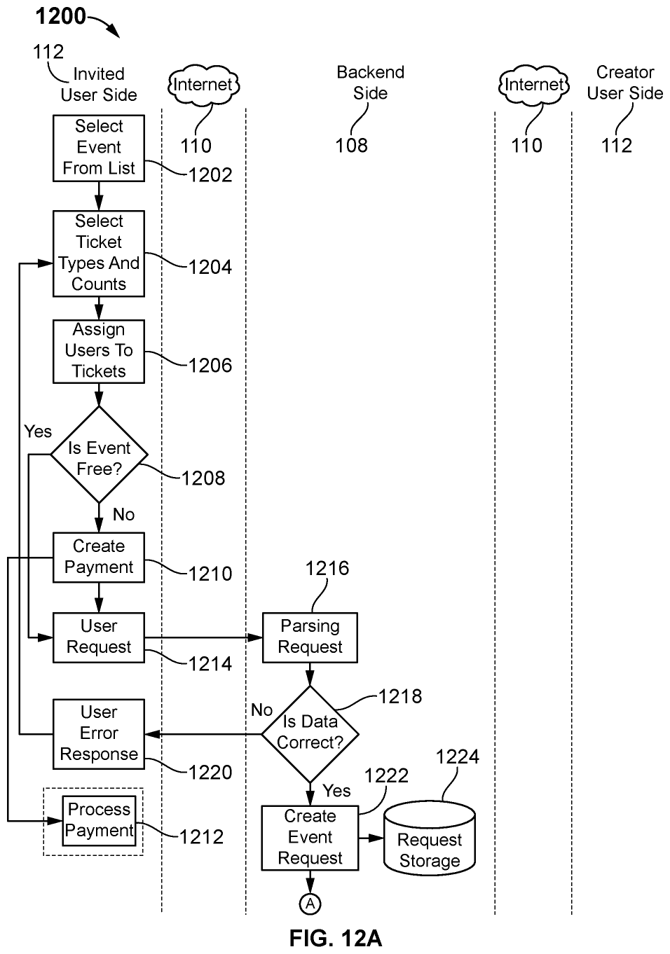

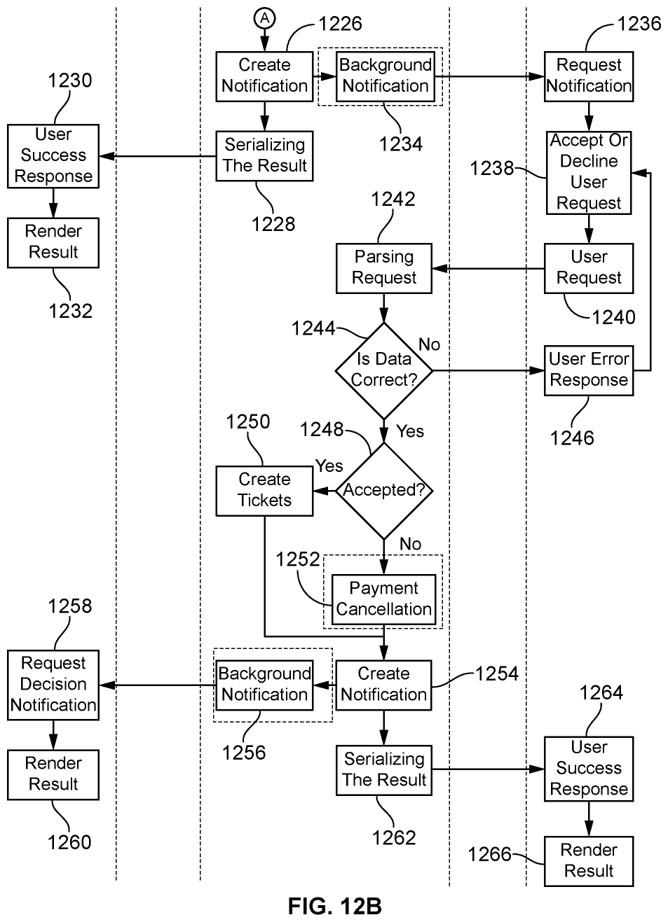

Referring to FIG. 12, a flowchart 1200 of a method for allowing attendees to purchase a ticket to a selected event, according to an embodiment, is illustrated. In an embodiment, the method shows a plurality of steps used in the process of purchasing a ticket to the selected event. At steps 1202 and 1204, the invited guest selects an event from a list including a plurality of events and further selects ticket types and counts (number of desired tickets). At step 1206, tickets are assigned. At step 1208, a determination is made as to whether the event is free or not. If the event freely allows the invited guest, then the invited guest needs not to pay any payment. At steps 1210 and 1212, the attendee makes payment for purchasing one or more tickets if the event requires a payment. At step 1214, the request is sent to the server 108. At step 1216, the request is parsed. At step 1218, a determination is made as to whether the request data is correct (valid) or not. If it is invalid, then at step 1220 control passes back to user computing device 112 with an error message.

At step 1222, an event request is created by the system 100, wherein the requests are stored in the request storage database 1224. At step 1226, at least one notification is created. At step 1228, the result is serialized, and at step 1232, the user computing device 122 is sent an indication that the event request was successfully processed. At step 1232, the user's computing device 112 displays a message indicating the successful event request processing. At step 1234, a notification of the event request is generated in the background. At step 1236, the host of the event requests notification of all event acceptances. In step 1238, the host can accept or decline the event request. In step 1240, the host (user) sends a request to the server 108 including information as to whether the host accepted event request. At step 1242, the host (user) request is parsed. In step 1244, a determination is made as to whether the parsed host request is correct (valid). If the host request is invalid, then control passes to the host user computing device 122 where an error is displayed at step 1246.

At step 1248, the system 100 checks whether the host accepts the request from the invited guest for attending the event. At step 1250, if the host accepts the request, then the system 100 creates one or more tickets. At step 1252, if the host chooses not to accept the request, then the system 100 cancels payments. At steps 1254 and 1256, one or more notifications are created, and background notifications are created to refresh the data in the background. At steps 1258, request decision notifications are sent. Further, at step 1260, results are provided for the invited guest. At step 1262, the results are serialized. At step 1264, the user response is successfully generated. Further, at step 1266, results are provided for the user.

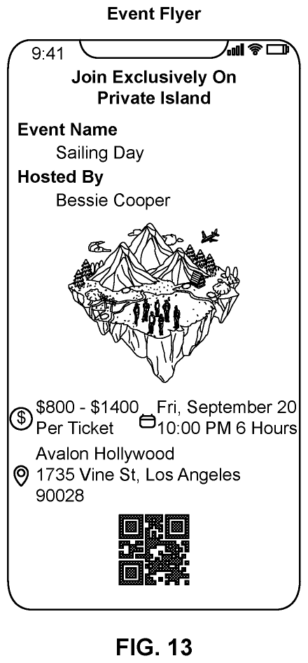

FIGS. 13-28 illustrate example screens (graphical user interfaces) for an implementation of the mobile device application (“app”). The illustrated screens are not meant to be limiting or represent a complete set of such screens. It is to be understood that some of the display screens in an implementation could have a different functionality, arrangement, and/or look and feel. Some of the screens in an implementation could be optional. Still other screens and functionality in various implementations could be provided (such as the visualization map 200 (FIG. 2)). It is to be further appreciated that there would necessarily be an underlying computer-implemented aspect to each of the screens. Furthermore, it is to be understood that instead of, or in addition to, an “app,” similar functionality might be achieved using a web-based application (such as a browser-based application), a standalone desktop program, a tablet-based application, or combinations thereof.

Referring to FIG. 13, an example event flyer is shown including the event visualization discussed previously. When sharing an event, the event flyer is generated containing the event visualization, name of event and host, event date, event location, and an event price (if not a free event). A QR code (or another type of scannable encoding, preferably a 3D bar code) may also be included which links to a page to request registering for the event and/or to a page containing more information about the event, for example. By scanning the QR code using an appropriate QR code scanner, the user can be taken to a specific web page.

Referring to FIGS. 14, an example user profile screen is shown. A user profile includes information about a user that may be viewed by other users of the social network. The user may upload a photo and provide a short message and links to other websites. Alternatively, the user may select or design an avatar to be used in place of, or in addition to, the photo. Additionally, the user profile may include other personal information, such as, for example, lists of interests such as hobbies, music, movies, books; and personal information such as gender, age, marital status, location, and so forth. Further, a list of past and future events that the user has attended, or will attend, may be included. Still further, and as will be described in greater detail, a user rating such as the illustrated “vibe score” may be provided reflecting social interactions.

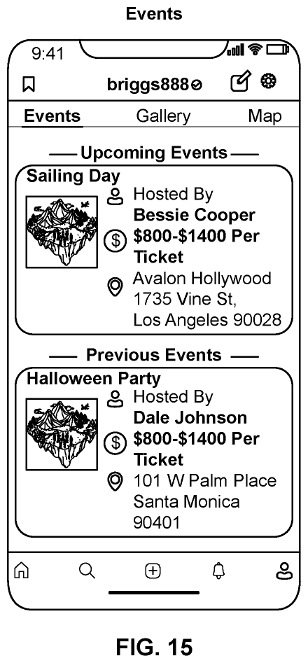

Referring to FIG. 15, from a selected events tab or the like, the user is presented with past and future events, along with pertinent information for each event such as an event description, event date, host name, location, and pricing. In an embodiment, the user may click on (or otherwise select) an illustrated event so as to obtain information about the event and to have the opportunity to request joining the event.

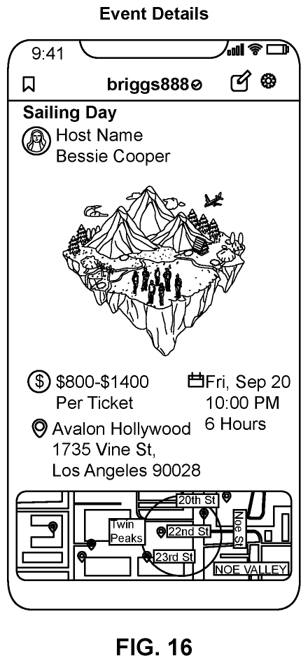

Referring to FIGS. 16-18, the user is provided with detailed information about the event. In the illustrated example such information includes the event name, host name, venue location, event date and time, ticket price, description, map of the venue, and what is included. In addition, a media gallery can be includes having photo and/or video content relative to the event. A list of participants including those who were accepted and those requesting to join the event can be shown. Additionally, the user can be presented with a mechanism to request to join the event, such as the illustrated “Request to join” button.

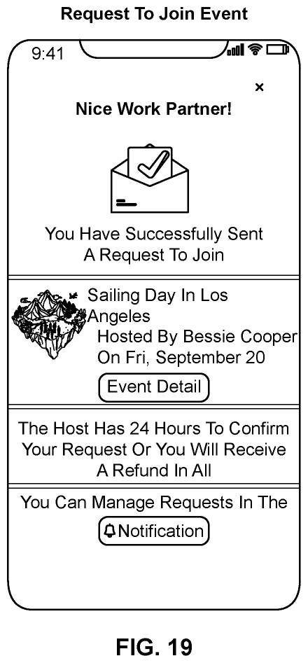

Referring to FIG. 19, an example notification that the user has successfully requested to attend the event is shown.

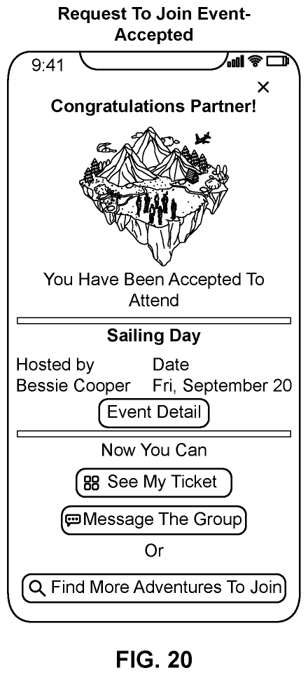

Referring to FIG. 20, an example notification that the user has been accepted to attend the event is shown.

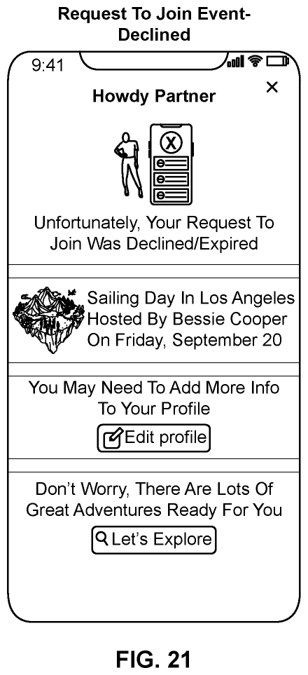

Referring to FIG. 21, an example notification that the user has been declined from attending the event is shown.

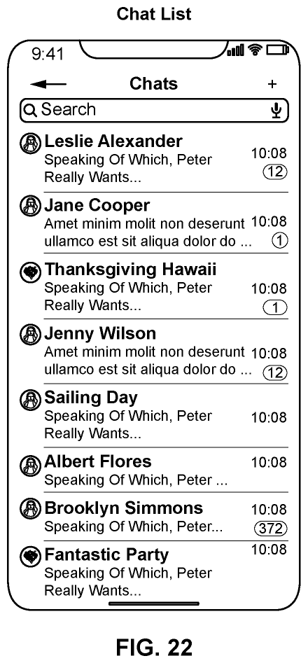

Referring to FIG. 22, a list of chats is shown. Once the user has been accepted to attend the event, the user will have access to the group chat for the event.

Referring to FIGS. 22-24, the user may join the event group chat. This allows the attendees to get to know each other and to share photos, videos, and experiences. The figures show various group chat activity.

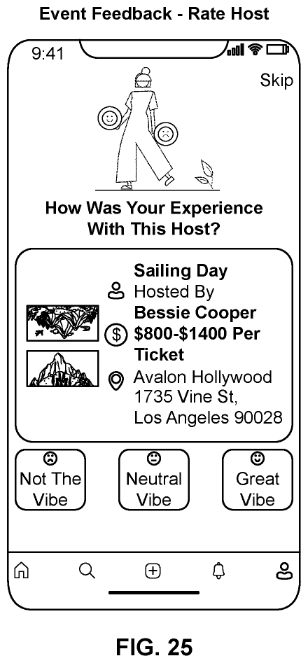

Referring to FIG. 25, after an event, participants can rate the host.

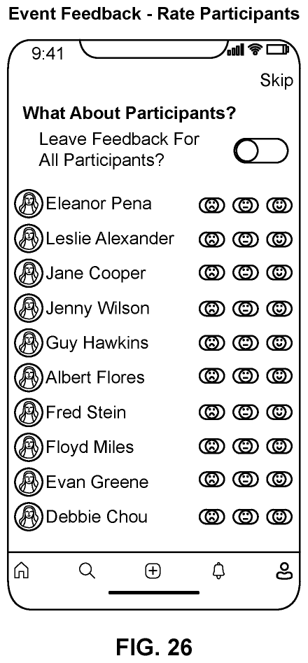

Referring to FIG. 26, after an event, the host and participants can each rate all other attendees' “vibe.” As shown, there are three options to determine how one enjoyed the experience from the host or socializing with the users of the event. The options range from negative, neutral/moderate, to a great experience. These ratings are recorded in a database and influence the user's trust score. The trust score appears on the user's profile for all other users to see. It is displayed as “vibe check” (see FIG. 4) and may take the form of a letter rating (A-F), a score rating (1-1000 scale), or a level (level 1-100) display, for example. This rating may be used to rank users, determine eligibility for certain actions and requests, and be an indicator of a user in good standing.

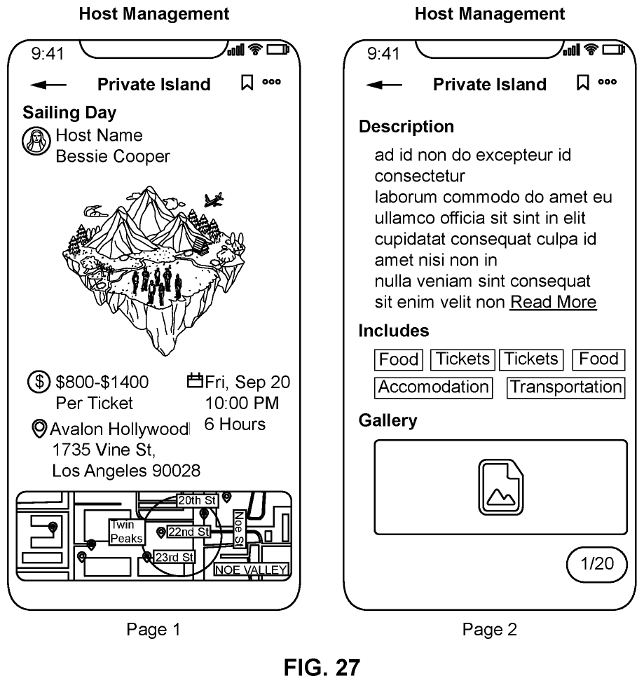

Referring to FIG. 27-29, the host is provided with various display screens to browse the event details and manage various aspects of the event.

Although the features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method for creating an event visualization, comprising:
obtaining event information;
identifying properties of the event, based on the obtained event information;
selecting a background layer;
selecting a plurality of foreground layers, each based on one of the identified properties of the event; and
combining the background layer and the foreground layers to form the event visualization;
wherein the created event visualization is shareable on one or more social network.

2. The method for creating an event visualization of claim 1, wherein the background layer comprises a 3D graphical illustration.

3. The method for creating an event visualization of claim 1, wherein the 3D graphical illustration is an isometric illustration.

4. The method for creating an event visualization of claim 1, wherein the event visualization relates to a private scheduled event.

5. The method for creating an event visualization of claim 1, wherein at least one of the identified properties of the event relate to attendees of the event.

6. The method for creating an event visualization of claim 5, wherein the at least one of the attendees is represented as an avatar on one of the foreground layers.

7. The method for creating an event visualization of claim 1, wherein the event visualization is placed on a visualization map along with other visualization events.

8. The method for creating an event visualization of claim 7, wherein the visualization map is filterable.

9. The method for creating an event visualization of claim 7, wherein the visualization map is filterable by one or more of time, location, and category.

10. The method for creating an event visualization of claim 1, wherein the event visualization is published on a social network.

11. The method for creating an event visualization of claim 1, wherein the event visualization is published on more than one social network.

12. The method for creating an event visualization of claim 1, wherein the event visualization is disseminated by one or more of email, text message, QR code, and social media posting.

13. A system for creating an event visualization for a scheduled event, comprising:
a server;
a plurality of computing devices linked to the server via the Internet;
wherein, using one of the computing devices, a user is capable of requesting creation of the event visualization for the scheduled event; and
wherein the event visualization includes a 3D graphical illustration including a plurality of graphical information representing event information.

14. The system of claim 13, wherein the 3D graphical illustration is an isometric illustration.

15. The system of claim 13, wherein the event visualization is placed on a visualization map along with other visualization events.

16. The system of claim 15, wherein the visualization map is filterable.

17. The system of claim 15, wherein the visualization map is filterable by one or more of time, location, and category.

18. The system of claim 13, wherein the event visualization enables purchasing a ticket to the event.

19. The system of claim 13, wherein the event visualization is for a private event.
